(19) United States
(12) Patent Application Publication
(10) Pub. No.: US 2015/0027827 A1
(43) Pub. Date: Jan. 29, 2015

(54) Control of clamp mechanism by means of a variable thickness disc

(71) Applicant: David Rogers Campbell, Richland, WA (US)

(72) Inventor: David Rogers Campbell, Richland, WA (US)

(21) Appl. No.: 13/987,424

(22) Filed: Jul. 24, 2013

(51) Int. Cl. F16D 65/12

(52) U.S. Cl. CPC F16D 65/12
USPC 188/218 XL

(57) ABSTRACT

A clamp mechanism uses a fixed spring force input caliper with friction pads in frictional contact with a variable thickness portion of a disc, where the disc thickness, thus the clamp force, varies as the disc rotates through one rotation or less.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

A motor vehicle brake has a rotor or drum rotating through many revolutions, often at high rotational velocities, so the force of the friction pads against the rotor or drum must be approximately constant for every degree position of one rotation. The thickness of the disc, or diameter of the drum, where the friction pads contact, is constant for every degree angle through one rotation. The braking force is varied by applying a variable force to the friction members via the caliper.

For slowly moving or static applications with low velocities, or systems that rotate through less than one revolution, simple clamping mechanisms exist that require an external, variable force input to accomplish a variable clamping or braking output with respect to force between the friction pads and disc when turned through less than one rotation. The goal of the present Invention is to simplify such a mechanism to vary the clamping force without an externally varying force.

### BRIEF SUMMARY OF THE INVENTION

The present Invention overcomes the limitation of clamping or braking mechanisms being unable to create a variable force through less than one rotation without a complex external control mechanism, with a fixed spring force clamp mechanism with friction pads, and a rotor with a variable thickness. The mathematical function of the variable force is in the rotor by varying the thickness of the rotor by the mathematical function. A disc clamping or braking system is assumed, but the principles also apply to drum systems.

### BRIEF DESCRIPTION OF THE SEVERAL VIEWS OF THE DRAWINGS

FIG. 1 is a side view of a clamp mechanism, with disc (1), caliper (2), friction pads (3) and (4) are in frictional contact with (1), and (5) is a spring.

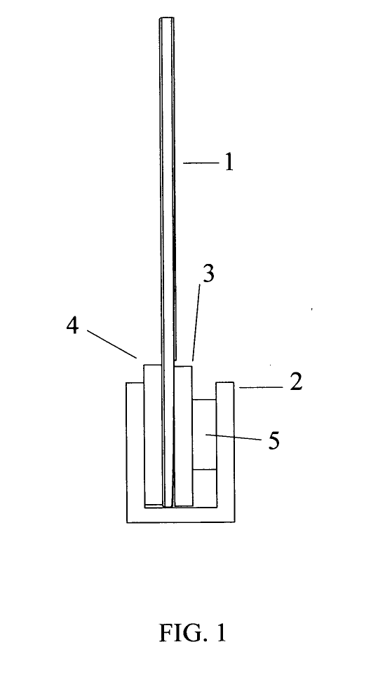

FIG. 2 is a front view, an inclined surface (6) is formed into (1) so the thickness of (1) varies where (3) and (4) contact it.

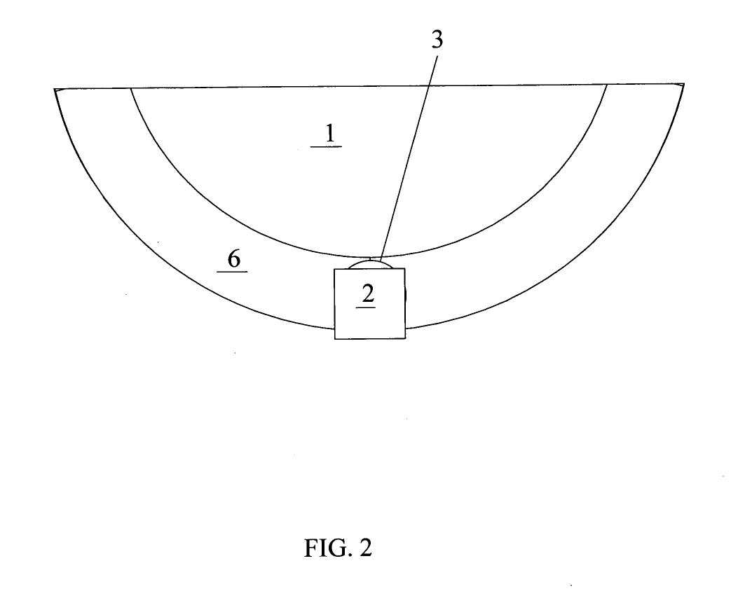

### DETAILED DESCRIPTION OF THE INVENTION

Systems such as automotive disc brakes apply an external, variable force to a caliper that forces friction pads against a disc. The disc, where the friction pads contact, is of constant thickness for every degree of its rotation through one revolution, and the system output is a variable force. Such a system is too complex and expensive for a simple clamping system where the system rotates through one rotation or less and a variable force through that rotation is required.

The present Invention is a simplified clamping mechanism with a spring loaded caliper having a constant spring force input. A variable clamping force output is produced by variation in the discs thickness. As the disc rotates through one revolution or less, variation in the discs thickness causes motion of one or both friction pads against the clamp spring force, changing the spring force, thus changing the clamping force. It is intended for applications where a load rotates at low velocity and through either one rotation or less, or through a small number of rotations at low velocity.

This Invention uses a clamp disc whose thickness, on the areas with which the friction pads make contact, varies as a function of degree angle of rotation, allowing a fixed mechanical force input from a spring to produce a variable clamping force without a complex control and feedback system to vary the input force. The variable function is machined into the rotor and should be relatively smooth to keep the friction pads surfaces in contact with the disc. The output force is a function of degree angle, thickness of the rotor across the average of points with which the friction pads make contact, the coefficient of frictions of the materials in frictional contact and the caliper spring rate. This mechanism eliminates the variable caliper and variable force input to accomplish a variable force output, and a feedback system to sense the rotor position to control the output force. As the disc rotates, changes in disc thickness, relative to the friction pads, cause a change in position of one or both friction pads, which causes a change in length of the spring which presses the pads against the disc, so the variation in disc thickness controls the spring force, thus the friction force of the pads against the disc.

The inventor claims:

1. A variable force clamping mechanism comprising:
a. a clamp mechanism with fixed input force from a spring or the like,
b. friction pads operated by said mechanism,
c. a disc whose thickness about its circumference varies with respect to degree angle about said disc,
d. said pads in frictional contact with the portion of said disc having variable thickness.

2. Variation in thickness of said disc, relative to the position of said pads, causing a corresponding variation in the position of one or both of said pads, causing a proportional variation in the spring input force of said mechanism, producing a proportional change in friction force between said pads and said disc.
